(19) United States
(12) Patent Application Publication
(10) Pub. No.: US 2008/0229149 A1
(43) Pub. Date: Sep. 18, 2008

(54) REMOTE TESTING OF COMPUTER DEVICES

(76) Inventor: Clifford Penton, Abingdon (GB)

Correspondence Address: STRATEGIC PATENTS P.C.., C/O PORTFOLIOIP, P.O. BOX 52050, MINNEAPOLIS, MN, 55402, US

(21) Appl. No.: 11/686,227

(22) Filed: Mar. 14, 2007

(51) Int. Cl. G06F 11/00

(52) U.S. Cl. 714/30

(57) ABSTRACT

In embodiments of the present invention improved capabilities are described for a method and system of software testing that may used on a computer network, the network may include a plurality of computer devices; may use a network management system to transmit test data over the computer network to at least one of the plurality of computer devices; test configuration settings on the at least one computer device using the transmitted test data; and report an actual test result of the at least one computer device back to the network management system.

### BACKGROUND

1. Field

The invention relates to remotely testing the configuration and security levels of a plurality of computer devices from a remote location on a computer network. The tested computer devices return an indication of the compliance to the test requirements.

2. Description of the Related Art

Both computer devices that are not properly configured and computer devices that are not protected against threats with up-to-date malware definitions are at risk of receiving malware through communication with other computer devices. The security of an entire computer network may be breached when just one computer device on the network becomes infected with malware. Verifying that a set of computer devices on a network are properly configured against malware, including verifying that the computer devices contain up-to-date malware definitions, may require an individual inspection of each of the devices. Each of these inspections may be manual, time consuming, error prone, and may not provide a rapid response to a potential threat. Generally, a need exists for a method and system for triggering and conducting automatic testing of a plurality of computer devices on a network. In the area of malware detection and prevention, a need exists for such testing to be directed at checking computer device configurations and malware definitions.

### SUMMARY

A method and system disclosed herein may include providing a computer network, the network including a plurality of computer devices; using a network management system to transmit test data over the computer network to at least one of the plurality of computer devices; testing configuration settings on the at least one computer device using the transmitted test data; and reporting an actual test result of the at least one computer device back to the network management system. The computer network may be a LAN, a WAN, a peer-to-peer network, an intranet, an Internet, or the like. The computer network may be a wired network, a wireless network, a combination of a wired network and a wireless network, or the like. The computer device may be a server computer, a desktop computer, a laptop computer, a tablet computer, a handheld computer, a smart phone, or the like.

The test data may be a European Institute for Computer Antivirus Research (EICAR) file. The test data may be a text file. The test data may be an executable file. The executable file may be an EXE file, a COM file, an ELF file, a COFF file, an a.out file, an object file, a shared object file, or the like. The test data may be an interpretable file, a source file, a configuration file, or the like. The test data may be some other form data which allows a computer device condition to be tested.

The test data may be executed on the at least one computer device. The test data may be scanned by a software application on the at least one computer device. The test data may provide information to a software application on the at least one computer device. The software application may execute using the test data information.

The actual test report may be returned to the network management system. The actual test report may provide a pass/fail status of the at least one tested computer device. The actual test report may provide summary information on the configuration settings for the at least one computer device. The actual test report may provide detailed information on the configuration settings for the at least one computer device. The actual test report may provide indicia of corrective actions for the at least one of the computer devices. The actual test report may provide an aggregation of actual tests for all of the tested computer devices. The aggregation report may be a table, a spreadsheet, a chart, a color, an icon, an XML object, or the like. The aggregation report may be plain text.

A method and system disclosed herein may include providing a computer device, the computer device requesting test data be transferred from a network management system; testing configuration settings on the computer device using the test data; and reporting an actual test result of the computer device back to the network management system. The computer network may be a LAN, a WAN, a peer-to-peer network, an intranet, an Internet, or the like. The computer network may be a wired network, a wireless network, a combination of a wired network and a wireless network, or the like. The computer device may be a server computer, a desktop computer, a laptop computer, a tablet computer, a handheld computer, a smart phone, or the like.

The test data may be a European Institute for Computer Antivirus Research (EICAR) file. The test data may be a text file. The test data may be an executable file. The executable file may be an EXE file, a COM file, an ELF file, a COFF file, an a.out file, an object file, a shared object file, or the like. The test data may be an interpretable file, a source file, a configuration file, or the like. The test data may be some other form data which allows a computer device condition to be tested.

The test data may be automatically downloaded from the network management system before the test is performed.

The test data may be executed on the computer device. The test data may be scanned by a software application on the computer device. The test data may provide information to a software application on the computer device. The software application may execute using the test data information.

The actual test report may be returned to the network management system. The actual test report may provide a pass/fail status of the tested computer device. The actual test report may provide summary information on the configuration settings for the computer device. The actual test report may provide detailed information on the configuration settings for the computer device. The actual test report may provide indicia of corrective actions for the computer devices.

A method and system disclosed herein may include providing a computer network, the network including a plurality of computer devices; aggregating at least one list of computer devices to receive test data using a network management system; using the network management system to determine a time to transmit the test data and transmit the test data at the determined time over the computer network to at least one of the lists of computer devices; testing configuration settings on the at least one computer device using the transmitted test data; and reporting an actual test result of the at least one computer device configuration back to the network management system. The computer network may be a LAN, a WAN, a peer-to-peer network, an intranet, an Internet, or the like. The computer network may be a wired network, a wireless network, a combination of a wired network and a wireless network, or the like. The computer device may be a server computer, a desktop computer, a laptop computer, a tablet computer, a handheld computer, a smart phone, or the like. The list may be a database, a table, an XML file, a text file, a spreadsheet file, or the like. The list may include at least one computer device.

The time to transmit may be executed manually for each transmission. All of the at least one list may be transmitted at the same time. Some of the at least one list may be transmitted at the same time. The time to transmit may be executed manually for each of the at least one list. The time to transmit may be executed manually based on a received alert.

The time to transmit may be executed automatically. The time to transmit may be executed on a schedule. The schedule may include a repetitive predetermined time. The schedule may include a random time. All of the at least one list may be transmitted at the same time. Some of the at least one list may be transmitted at the same time. The time to transmit may be executed automatically based on a received alert.

The test data may be a European Institute for Computer Antivirus Research (EICAR) file. The test data may be a text file. The test data may be an executable file. The executable file may be an EXE file, a COM file, an ELF file, is a COFF file, an a.out file, an object file, a shared object file, or the like. The test data may be an interpretable file, a source file, a configuration file, or the like. The test data may be some other form data which allows a computer device condition to be tested.

The test data may be executed on the at least one computer device. The test data may be scanned by a software application on the at least one computer device. The test data may provide information to a software application on the at least one computer device. The software application may execute using the test data information.

The actual test report may be returned to the network management system. The actual test report may provide a pass/fail status of the at least one tested computer device. The actual test report may provide summary information on the configuration settings of the at least one computer device. The actual test report may provide detailed information on the configuration settings of the at least one computer device. The actual test report may provide indicia of corrective actions for the at least one of the computer devices. The actual test report may provide an aggregation of configurations for all of the tested computer devices. The aggregation report may be a table, a spreadsheet, a chart, a color, an icon, an XML object, or the like. The aggregation report may be plain text.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a block diagram of a network level computer device testing method.

### DETAILED DESCRIPTION

The present invention may provide systems and methods for introducing test threats to a computer system and monitoring the computer system's reaction. Embodiments of the present invention may allow a system administrator to perform such operations over a computer network so that the system administrator need not have physical access to the computer system that is being tested. Moreover, embodiments of the present invention may allow a system administrator to test a set of computer systems en masse, perhaps with a single click at a system administrator's console. Additionally, the en mass computer system testing may be performed by an organizational group, by a computer system type, or by other computer system group determined by the system administrator. During the testing of the computer systems, the computer system user may not be aware the computer system is being tested. Other aspects of the present invention are described hereinafter, are described elsewhere, and/or will be appreciated. All such aspects of the present invention are within the scope of the present disclosure.

Computer systems may be operatively coupled via a computer network. This computer network may comprise a local area network, a virtual private network, or other protected computer network that is in some way segregated from the public Internet, a wide area network, a metropolitan area network, or some other unprotected computer network.

A threat may be intentionally or unintentionally introduced to a computer system on the protected computer network. Without limitation: A threat may comprise malicious software (or “malware”) such as a virus, a worm, a Trojan horse, a time bomb, a logic bomb, a rabbit, a bacterium, and so on. A threat may comprise spoofing, masquerading, and the like. A threat may comprise sequential scanning, dictionary scanning, or other scanning. A threat may comprise or be associated with snooping or eavesdropping such as digital snooping, shoulder surfing, and the like. A threat may be associated with scavenging such as dumpster diving, browsing, and the like. A threat may comprise spamming, tunneling, and so on. A threat may be associated with a malfunction such as an equipment malfunction, a software malfunction, and the like. A threat may be associated with human error such as a trap door or back door, a user or operator error, and so on. A threat may be associated with a physical environment such as fire damage, water damage, power loss, vandalism, acts of war, acts of god, a root kit, spyware, a botnet, a logger, dialer, and the like.

In some cases, the computer system may be properly configured so that the threat is unable to breach the computer system. A proper configuration of the computer system may encompass appropriate system settings; an installation of anti-threat software that is functioning correctly and that has up-to-date threat definitions; and so on. Anti-threat software may comprise anti-malware software, anti-virus software, anti-worm software, anti-Trojan-horse software, anti-time-bomb software, anti-logic-bomb software, anti-rabbit software, anti-bacterium software, anti-spoofing software, anti-masquerading software, anti-sequential-scanning software, anti-dictionary-scanning software, anti-scanning software, anti-snooping software, anti-eavesdropping software, anti-digital-snooping software, anti-shoulder-surfing software, anti-scavenging software, anti-dumpster-diving software, anti-browsing software, anti-spamming software, anti-tunneling software, anti-malfunction software, anti-equipment-malfunction software, anti-software-malfunction software, anti-human-error software, anti-trap-door software, anti-back-door software, anti-user-error software, anti-operator-error software, anti-fire-damage software, anti-water-damage software, anti-power-loss software, anti-vandalism software, anti-act-of-war software, anti-act-of-god software, firewall software, intrusion detection and prevention software, a passive system, an active system, a reactive system, a network intrusion detection system, a host-based intrusion detection system, a protocol-based intrusion detection system, an application protocol-based intrusion detection system, an intrusion prevention system, an artificial immune system, an autonomous agent for intrusion detection, virtualization, a sandbox, anti-spyware software, anti-botnet software, anti-logger software, anti-dialer software, and the like. Similarly, threat definitions may comprise malware definitions, threat definitions, Trojan horse definitions, script definitions, and so on.

In other cases, however, the computer system may be improperly configured and may be breached when the threat is introduced. An improper configuration of the computer system may encompass misconfigured system settings, an installation of anti-threat software that is malfunctioning or that does not have up-to-date threat definitions, and so on. In some cases, a threat may itself target the computer system so as to maliciously reconfigure the system settings, cause anti-threat software to malfunction, remove or prevent the installation of up-to-date threat definitions, and so on.

Some computing systems may provide a report as to whether threat definitions are up-to-date, whether anti-threat software is installed and enabled, and so on. Unfortunately, if the computer system has been compromised or misconfigured then such reports may be inaccurate or misleading. To compensate for this, it may be possible to test the computer system by intentionally introducing a threat and monitoring the computer system's automatic response, if any. By monitoring the computer system in action as it reacts to the threat, it may be possible to see whether the computer system is properly configured regardless of what the computer system may report.

The present invention may provide systems and methods for introducing test threats to a computer system and monitoring the computer system's reaction. Embodiments of the present invention may allow a system administrator to perform such operations over a computer network so that the system administrator need not have physical access to the computer system that is being tested. Moreover, embodiments of the present invention may allow a system administrator to test a set of computer systems en masse, perhaps with a single click at a system administrator's console. Other aspects of the present invention are described hereinafter, are described elsewhere, and/or will be appreciated. All such aspects of the present invention are within the scope of the present disclosure.

Throughout this disclosure, uses of the verb “to execute” may generally refer to acts of software execution, software interpretation, software compilation, software linking, software loading, software assembly, any and all combinations of the foregoing, and any and all other automatic processing actions taken in any and all orders and combined in any and all possible ways as applied to software, firmware, source code, byte code, scripts, microcode, and the like.

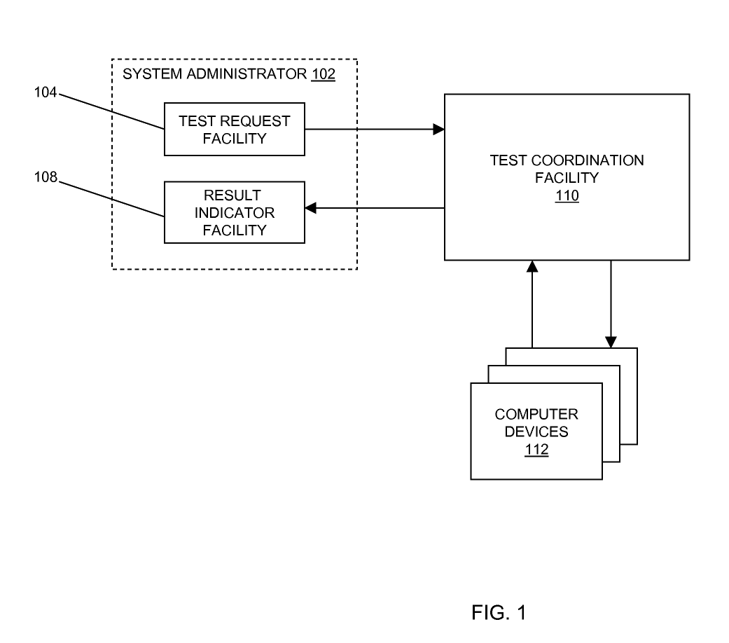

Referring now to FIG. 1, in embodiments of the present invention a system administrator 102 may access a test coordination facility 110 to test the configuration, settings, software versions, threat definition update versions, or the like on a plurality of computer devices 112. The system administrator 102 may access a test request facility 104 to request that the test coordination facility 110 transmit test data to at least one of the plurality of computer devices 112. Embodiments may provide a “push to test” capability that allows the system administrator 102 to issue this request with a single click of a user-interface element. In any case, the test coordination facility 110 may use information received from the test request facility 104 to determine the test data to transmit to the at least one of the plurality of computer devices 112. The computer devices 112 may use the test data to determine the configuration levels, software versions, threat definitions, and the like of the computer device 112. The computer devices may transmit results from running the test data back to the test coordination facility 110, which may then transmit the results to the system administrator 102. Alternately, the test coordinator 110 may compare the results from the computer devices 112 to expected results for the computer device 112 and the comparison of results may be transmitted to the system administrator 102. The system administrator 102 may access a result indicator facility 108 where the results from the test coordination facility may be displayed as individual computer device 112 results, aggregated results for a number of the computer devices 112, or the like.

In embodiments, the system administrator 102, the test coordination facility 110, and computer devices 112 may operate within or in association with a computer network. The computer network may include a LAN, WAN, peer-to-peer network, intranet, Internet, or the like. The computer network may also be a combination of networks. For example, a LAN may have communication connections with a WAN, intranet, Internet, or the like and therefore may be able to access computer resources beyond the local network. The network may include wired communication, wireless communication, a combination of wired and wireless communications, or the like. The computer devices on the network may include a server, a desktop computer, a laptop computer, a tablet computer, a handheld computer, a smart phone, or the like.

In an embodiment, a central system security product may be tested where the configuration, settings, software versions, threat definition update versions, or the like of the central system security product is tested for threat security. The central system security product may be responsible for the configuration policy of the central system client devices and may report on security threats of the client devices. In the central system security product, the client devices may not include individual security applications. In an embodiment, the central system may be used to deploy a test threat to the central system clients and the system administrator 102 may observe the client test results through the central system. During the threat test, the central system may or may not be aware that a test is in progress. Additionally, during the threat testing of the clients, the clients may not be aware that the threat testing is in progress.

In an embodiment, a central system application product may be tested where the configuration, settings, software versions, or the like of the central system product may be tested for conformity to defined configurations, system settings, software versions, or the like. The central system product may be responsible for the configuration policy of the client devices for the type and version of software that may be used by a client device. The central system may report on configuration deficiencies of the clients in relation to a central system product defined standard. In an embodiment, the central system may be used to deploy a test to the central system clients to determine configurations, software versions, and the like and the system administrator 102 may observe the client test results through the central system. During the test, the central system may or may not be aware that a test is in progress. Additionally, during the testing of the clients, the clients may not be aware that the testing is in progress.

The system administrator 102 may access the test request facility 104 to configure the testing of the plurality of computer devices 112. In embodiments, the test request facility 104 may be an application, a dashboard, a widget, a webpage, or the like with which the system administrator may configure the test data to be used for testing the computer devices 112. The system administrator 102 may indicate a set of threats to test, aspects of the computer device to test, expected results of the test, the computer devices to be tested, or the like. Such indications may be applied individually or in combination. In embodiments, the system administrator 104 may provide a list of tests to be performed, select the test from a presented list of test, indicate a file that may contain a list of test to perform, indicate a website that may contain a list of test to perform, or the like.

In addition to the test selection, the system administrator 102 may indicate the computer devices to test. In embodiments, the system administrator 102, using the test request facility 104, may select individual computer devices, computer devices within a portion of the network, similar computer devices, computer devices with similar software applications, computer devices with similar operation systems, all computer devices, or the like. For example, the system administrator 102 may select all laptop computers that are running Windows XP to be tested for protection from a certain malware or class of malware. In another example, the system administrator 102 may select a group of computer devices 112, such as in a sales department, which may have greater access to external networks, to assure that their computer devices have the latest threat definitions.

In embodiments, the system administrator 102 may also use the test request facility 104 to create test configuration combinations where certain computer devices may receive certain types of test data. These combinations may be created by type of computer device 112, by type of software application, by location within an enterprise, by location within the network, by organizational group, or the like. In embodiments, these combinations may be predefined and the system administrator 102 may be able to select one or more of the combinations to which to send test data.

In embodiments, the system administrator 102 may use the test request facility 104 to set a time of transmit for the test data to the computer devices 112. For example, the system administrator 102 may select a group of computer devices 112 to receive the test data after working hours to minimize the disturbance to the users. The time of transmit may include a frequency in which to transmit the test data such as once a day, once a week, once a month, or the like. The test data may be sent at the set frequency, may be randomly transmitted within a period of time at the set frequency, may be randomly transmitted, or the like. The time of transmit for the test data may be set for an individual computer device 112, a group of computer devices 112, a combination of computer devices, all the computer devices, or the like. In embodiments, the time of transmit information may be stored as a database, a table, an XML file, a text file, a spreadsheet, or the like.

In embodiments, the system administrator 102 may update the test data and transmit a test request to the coordination facility 110 based on a received threat. The system administrator 102 may receive threat information from a service; the threat information may be automatically transmitted, may transmit when queried, or the like. When a new threat notification is received from the service, the system administrator 102 may update the appropriate test data and request the test coordination facility 110 to test the computer devices 112 for the new threat. In embodiments, it may be predetermined which computer devices 112, computer device 112 group, computer device 112 combination, or the like to transmit the updated test data as a result of the received threat notification.

In embodiments, the test request facility 104 may automatically transmit a test request to the test coordination facility 110 based on a received threat notification. The test request facility 104 may be connected to a service that may provide threat information. The threat information may be automatically transmitted, may be transmitted when queried by the test request facility 104, or the like. When a new threat notification is received from the service, the test request facility 104 may update the appropriate test data and request the test coordination facility 110 to test the computer devices 112 for the new threat. In embodiments, it may be predetermined which computer devices 112, computer device 112 group, computer device combination, or the like to transmit the updated test data as a result of the received threat notification.

In embodiments, once the test request facility 104 has determined the test data configuration, the system administrator may manually or automatically transmit the test data configuration to the test coordination facility 110. In embodiments, the test coordination facility 110 may use the received test data configuration to coordinate which test to execute, on which computer devices to execute the test, when to execute the test, or the like. In embodiments, the test coordination facility 110 may receive the test data from the test request facility 104, may select the test data from data stored in the test coordination facility 110, or the like. The test data may include the threat to be tested, the computer devices 112 to be tested, the expected results, or the like.

In embodiments, the data file may comprise a European Institute for Computer Research (EICAR) file. Additionally, the test data may be a text file, an executable file (such as and without limitation an EXE file, a COM file, an ELF file, a COFF file, an a.out file, an object file, a shared object file, and the like), a configuration file, or the like, in which the system administrator 102 may be able to indicate general or specific threats to test. In embodiments, a non-executable file such as the EICAR file or text file may be transmitted to the computer device 112 where an application within the computer device, such as threat detection software, may be tested to determine if some information within the files is detected by the application.

In embodiments, the data file may be an executable file that may be transmitted to the computer devices 112. The executable file may run within the computer devices 112 to test configurations, determine software application versions, determine if threat applications are active, or the like.

In embodiments, the test coordination facility 110 may transmit the test data to the test request facility 104 determined computer devices, monitor the behavior of the computer devices in response to the data file, compare the recorded behavior to the expected behavior, determine if the computer devices 112 passed or failed the test, record the result of the test, transmit the test results to the result indicator facility 108, and the like.

The test coordination facility 110 may configure the test data and transmit the test data to the computer devices 112 determined by the test request facility 104. In embodiments, the test coordination facility 110 may receive a list of computer devices 112 to test from the test request facility 104, may determine the computer devices 112 to test based on parameters received from the test request facility 104, or the like. The test coordination facility 110 may use the test data information in combination with any time of transmit information that may be received from the test request facility 104 and may transmit the data file to the computer devices 112 at the determined time. The test coordination facility 110 may transmit the test data to an individual computer device 112, a group of computer devices 112, all the computer devices 112, or the like.

In embodiments, once the test data has been transmitted to the computer devices 112, the test coordination facility 110 may monitor the behavior of the computer devices 112 in response to the test data. For example, if an EICAR file was transmitted, the test coordination facility 110 may monitor if the computer devices 112 detect the threat within the EICAR file. In another example, if an executable file is transmitted, the test coordination facility 110 may monitor the activity of the executable file and may receive information on the computer device 112 from the executable file. The test coordination facility 110 may monitor the computer devices 112 for a set amount of time, until a completion indication is received from the computer devices 112, until a completion indication is received from the executable file, monitor periodically over a period of time, or the like.

In an embodiment, the test coordination facility 110 may detect a threat to a client device from a detected malware file. In this embodiment, it may not be necessary to transmit a threat test file to test the threat protection of a client device, an actual malware threat may be detected by a client and the test coordination facility 110 may record and report the threat detection to the system administrator 102.

During the time that the test coordination facility 110 may be monitoring the computer devices 112 for responses to the test data, the test coordination facility 110 may record the received responses. In embodiments, the responses may be recorded for a set amount of time, until a completion indication is received from the computer devices 112, until a completion indication is received from the executable file, monitor periodically over a period of time, or the like. The recorded responses may be recorded for each individual computer device 112, for a group of computer devices 112, or the like. The recorded responses may be stored individually, aggregated as a group of computer devices 112, or the like. In embodiments, the responses may be recorded for individual computer devices 112 and may then be aggregated by a computer device 112 group, computer device 112 combination, or the like. In embodiments, the computer devices 112 that the test request facility 104 indicated be tested may determine the aggregation level. In embodiments, the test coordination facility 110 may store the test data responses in a database, a table, an XML file, a text file, a spreadsheet, or the like.

In embodiments, once the test coordination facility 110 has received and recorded the response information from the tested computer devices 112, the responses may be compared to the expected behavior of the computer devices 112. In embodiments, the expected behavior may have been received from the test request facility 104, may be stored in the test coordination facility 110, may be determined from a set of parameters from the test request facility 104, or the like. The expected behavior may be a detection of a threat, the time required to detect a threat, a configuration of the computer devices 112, the software application version levels, the threat definition update date, or the like. From the comparison, the test coordination facility 110 may determine a pass/fail for each aspect of the test data, determine a level of acceptance of the test data, determine corrective action based on the received responses, or the like. For example, one result may be a corrective action to update the threat definitions. In embodiments, the tested computer devices may receive an overall rating, individual ratings for the test data, ratings for a specified group of computer devices 112, corrective action required to correct determined defects, or the like.

In embodiments, when the test coordination facility 110 transmits the test file to the computer devices 112, the test coordination facility 110 may provide a warning to the user of the test computer device 112 that may include information of what to expect as part of the test. In embodiments, once the testing is complete, the test coordination facility 110 may inform the user that the test has been completed; the information sent to the user may include the response information that the test coordination facility 110 may be recording. In embodiments, the user information may be a pop-up window, a splash screen, a webpage, an information window, or the like.

In embodiments, the results of the comparison between the recorded responses and the expected behavior may be reported to the result indicator facility 108. The result indicator facility 108 may be located with the system administrator 102 applications, as part of the test coordination facility 110, as a separate application, or the like. In embodiments, the result indicator facility 108 may provide an output window, a pop-up window, a dashboard, a widget, a splash screen, an application, a database application, or the like for reporting the statistics aggregated by the test coordination facility 110.

In one embodiment, the result indicator facility 108 may receive, store, and report the comparison results from the test coordination facility 110. Using the stored results, the system administrator 102 may display the results using the result indicator facility 108.

In another embodiment, the comparison results may be stored in the test coordination facility 110 and the result indicator facility 108 may provide reporting capabilities to the system administrator 102 by accessing the test coordination facility 110 stored comparison results.

The result indicator facility 108 may provide a number of views of the result data such as specific information for individual computer devices 112, aggregated information for a set group of computer devices 112, aggregated information for a selected group of computer devices 112, information for all the computer devices 112, or the like. The result indicator facility 108 may provide a single view of the result information or may provide a combination of views of the data. For example, a first view may provide result information for a selected group, such as the sales department, and a second view may provide specific information for the particular computer devices 112 within the sales department. In this manner, the system administrator may be able to determine the compliance of an entire group of computer devices 112 and also drill down into specific information or specific computer device 112. The system administrator 102 may view the sales department and see that the department did not pass the computer device 112 test and then drill down into the information to determine which computer devices within the sales department did not pass the test. Based on the presented information, the system administrator may be able to determine corrective action for the computer devices that did not pass the test.

Additionally, the result indicator facility 108 may display result information for more than one computer device 112 or group of computer devices 112. For example, the system administrator 102 may have initiated more than one computer device 112 test and the more than one test results may be displayed by the result indicator facility 108. As described, the system administrator 102 may be able to view and drill down into the information for any of the displayed test results. It will be appreciated that the result indicator facility 108 may display the test result information in a number of ways and combinations, any and all of which are within the scope of the present disclosure.

In embodiments, once the system administrator 102 has initiated a computer device 112 test, the test result information may be provided in a viewable form by the result indicator facility 108. In embodiments, the results may be viewed in real time, at set intervals of the testing, at the completion of the testing, when requested by the system administrator 102, automatically when the test coordination facility 110 determines the tests are complete, or the like. When the result information is viewed before the completion of the entire test, there may be an indication of which computer devices have completed the test and which are still running the test.

In embodiments, the result indicator facility 108 may provide different levels of information related to the compliance of the computer devices 112 to the test. The results may be a display of pass/fail for the computer devices 112 by indication of the words “pass” or “fail”, by color indicator (e.g. green or red), by a number rating, or the like. The pass/fail indication may provide a general view of the computer devices 112 to the system administrator 102, allowing a quick overall evaluation of the tested computer devices 112 to determine if any of the computer device 112 result information requires further investigation. This view may be most helpful when viewing a large number of computer devices 112 or an aggregation of computer device 112 information.

The test results may be displayed as a summary of information of the tested computer devices 112 such as information that reveals which computer devices 112 did not pass the test and the aspect of the test that was not passed; which computer devices 112 did pass the test; and so on. The summary reports may be aggregated by the aspect of the test that was not passed, by the computer device 112 group, by the test failure type, or the like. The system administrator 102 may indicate which of the summary information to display by selecting one or more types of information that are created by the test. In embodiments, such indication may be made by selecting a radio button, checking a box, selecting an item from a list, entering a code, and so on.

The test results may be displayed as detailed information of the tested computer devices 112. The detailed information may include the computer device 112 identification, the computer device 112 location, the results of the test aspects, possible corrective action to be taken, or the like. In embodiments, using the detailed information, the system administrator 102 may be able to determine a corrective action to be applied to a particular computer device 112 and may be able to send a message or email that describes the actions to be taken in order to bring the computer device 112 into compliance. The message or email may be addressed to a user of the computer device 112. In embodiments, the system administrator 102 may be able to send the message or email directly from the detailed report; the message or email may contain the some or all the information from the detailed report in addition to comments from the system administrator; and so on.

The system administrator 102 may be able to switch between or move amongst the different displayed information views. For example and without limitation: The system administrator 102 may begin the information review by viewing an overview of the tested computer devices 112. The system administrator 102 may identify a group of the computer devices 112 that appear to require additional investigation. The system administrator 102 may then select a summary view of the information for the selected computer devices 112. From the summary view, the system administrator may identify certain computer devices 112 for which to view detailed information and may select a one or more detailed views for these computer devices 112. From the one or more detailed views, the system administrator 102 may identify any number of corrective actions. Then, the system administrator 102 may switch back to the overview to determine if there are other computer devices 112 that may require a more detailed review.

In embodiments, the test result information views may be presented as a table, a spreadsheet, a chart, a color, an icon, an XML object, plain text, or the like. The types of view may be displayed individually or in combination. For example, the test results may be displayed as a chart of a group of test results and there may be an associated table, spreadsheet, or other presentation of data with detailed information related to the chart. The system administrator 102 may be able to select the chart or associated table to drill down into additional information. As the system administrator drills down into the information, the information displayed may also change. For example, as the system administrator 102 drills down into information displayed by the table of information, the chart may change to display the new drill down information.

In embodiments, the user of the computer device 112 may initiate a test of the computer device. For example, a user may have a laptop computer and may plan a business trip during which the laptop computer will be used on other computer networks. To assure that the computer device is protected from threats, the user may request a test of the computer device 112 prior to the trip.

In embodiments, the user may request that the test be executed. Such embodiments may provide a “push to test” capability that allows the user to issue this request with a single click of a user-interface element. In response to this request, the computer device 112 may itself request test data from the test coordination facility 110. The test coordination facility 110 may have the test data for the computer device 112 or may request the test data from the test request facility 104. The request for the test data may be displayed for the system administrator 102. The system administrator may select or create the test data to be executed on the requesting computer device 112. The test coordination facility 110 may then transmit the test data to the requesting computer device 112.

In embodiments, as the requesting computer device 112 is running the test, the test coordination facility 110 may monitor, record, report, or otherwise process the test information. The results of the requesting computer device 112 test may be viewed by the system administrator 102 using the result indicator facility 108. The system administrator 102 may determine both whether the requesting computer device is properly configured and what, if any, corrective actions are required to properly configure the requesting computer device. Additionally or alternatively, the user and/or the system administrator 102 may receive an indication as to whether the computer device 112 passed or failed the test.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method of software testing, comprising:
providing a computer network, the network including a plurality of computer devices;
using a network management system to transmit test data over the computer network to at least one of the plurality of computer devices;
testing configuration settings on the at least one computer device using the transmitted test data; and
reporting an actual test result of the at least one computer device back to the network management system.

2. The method of claim 1 wherein the computer network is a LAN.

3. The method of claim 1 wherein the computer network is a WAN.

4. The method of claim 1 wherein the computer network is a peer-to-peer network.

5. The method of claim 1 wherein the computer network is an intranet.

6. The method of claim 1 wherein the computer network is an Internet.

7-9. (canceled)

10. The method of claim 1 wherein the computer device is a server computer.

11. The method of claim 1 wherein the computer device is a desktop computer.

12. The method of claim 1 wherein the computer device is a laptop computer.

13-15. (canceled)

16. The method of claim 1 wherein the test data are a European Institute for Computer Antivirus Research (EICAR) file.

17. The method of claim 1 wherein the test data are a text file.

18. The method of claim 1 wherein the test data are an executable file.

19-27. (canceled)

28. The method of claim 1 wherein the test data are a configuration file.

29. (canceled)

30. The method of claim 1 wherein the test data are executed on the at least one computer device.

31. The method of claim 1 wherein the test data are scanned by a software application on the at least one computer device.

32. The method of claim 1 wherein the test data provide information to a software application on the at least one computer device.

33. The method of claim 32 wherein the software application executes using the test data information.

34. The method of claim 1 wherein the actual test report is returned to the network management system.

35-85. (canceled)

86. A method of software testing distribution, comprising:
providing a computer network, the network including a plurality of computer devices;
aggregating at least one list of computer devices to receive test data using a network management system;
using the network management system to determine a time to transmit the test data and transmit the test data at the determined time over the computer network to at least one of the lists of computer devices;
testing configuration settings on the at least one computer device using the transmitted test data; and
reporting an actual test result of the at least one computer device configuration back to the network management system.

87-149. (canceled)

150. A system of software testing, comprising:
a computer network, the network including a plurality of computer devices;
a network management system used to transmit test data over the computer network to at least one of the plurality of computer devices;
configuration settings tested on the at least one computer device using the transmitted test data; and
an actual test result report of the at least one computer device back to the network management system.

151-298. (canceled)
